(19) United States
(12) Patent Application Publication
(10) Pub. No.: US 2010/0131290 A1
(43) Pub. Date: May 27, 2010

(54) Artificial-intelligent system and method for managing health-care

(76) Inventor: Anuthep Benja-Athon, New York, NY (US)

Correspondence Address: ANUTHEP BENJA-ATHON, 210 E 36th St., New York, NY, 10016, US

(21) Appl. No.: 12/655,748

(22) Filed: Jan. 7, 2010

Related U.S. Application Data
(63) Continuation-in-part of application No. 12/381,654, filed on Mar. 16, 2009.
Application No. 12/381,654 is a continuation-in-part of application No. 12/321,141, filed on Jan. 16, 2009.
Application No. 12/321,141 is a continuation-in-part of application No. 12/069,409, filed on Feb. 11, 2008.
Application No. 12/069,409 is a continuation-in-part of application No. 11/986,657, filed on Nov. 26, 2007.
Application No. 11/986,657 is a continuation-in-part of application No. 11/803,621, filed on May 16, 2007.
Application No. 11/803,621 is a continuation-in-part of application No. 11/716,062, filed on Mar. 9, 2007.
Application No. 11/716,062 is a continuation-in-part of application No. 11/649,873, filed on Jan. 5, 2007, now abandoned.
Application No. 11/649,873 is a continuation-in-part of application No. 11/637,662, filed on Dec. 13, 2006, now abandoned.
Application No. 11/637,662 is a continuation-in-part of application No. 11/599,847, filed on Nov. 16, 2006.
Application No. 11/599,847 is a continuation-in-part of application No. 11/431,046, filed on May 10, 2006.
Application No. 11/431,046 is a continuation-in-part of application No. 11/543,895, filed on Oct. 6, 2006, now abandoned.
Application No. 11/543,895 is a continuation-in-part of application No. 11/523,945, filed on Sep. 21, 2006, now abandoned.
Application No. 11/523,945 is a continuation-in-part of application No. 11/510,820, filed on Aug. 28, 2006, now abandoned.
Application No. 11/510,820 is a continuation-in-part of application No. 11/477,121, filed on Jun. 29, 2006, now abandoned.
Application No. 11/477,121 is a continuation-in-part of application No. 11/114,763, filed on Apr. 27, 2005, now abandoned.
Application No. 11/114,763 is a continuation-in-part of application No. 11/196,823, filed on Aug. 4, 2005, now abandoned.
Application No. 11/196,823 is a continuation-in-part of application No. 11/973,866, filed on Oct. 11, 2007.
Application No. 11/973,866 is a continuation-in-part of application No. 11/293,689, filed on Dec. 5, 2005, now abandoned.
Application No. 11/293,689 is a continuation-in-part of application No. 11/150,878, filed on Jun. 13, 2005, now abandoned.
Application No. 11/150,878 is a continuation-in-part of application No. 11/074,236, filed on Mar. 7, 2005, now abandoned.
Application No. 11/074,236 is a continuation-in-part of application No. 11/022,410, filed on Dec. 27, 2004, now abandoned.

(51) Int. Cl. G06Q 50/00; G06F 17/30; G06F 3/048

(52) U.S. Cl. 705/2; 707/822; 715/760; 707/E17.009

(57) ABSTRACT

A system and method for expressing, associating and interacting individual groups of diagnoses, chief complaints and related categories on health and health-care services with individual specific interactive diagnoses, chief complaints and related categories on Web pages using systems of templates, drop-down lists and panels by physicians and patients.

This application is a continuation-in-part of Ser. No. 12/381,654 filed Mar. 16, 2009 entitled the Adaptable compositions of health information, a continuation-in-part of Ser. No. 12/321,141 entitled the Best system of health and health-care data management filed Jan. 16, 2009 which is a continuation-in-part of Ser. No. 12/069,409 entitled the Filing of Health and Heath-care data filed Feb. 11, 2008, continuation-in-part of Ser. No. 11/986,657 entitled A hierarchy of medical word headers filed Nov. 26, 2007, a continuation-in-part of Ser. No. 11/803,621 entitled Patients' and physicians' data management filed May 16/2007, a continuation-in-part of Ser. No. 11/716,062 entitled A sieve of words in health-care data filed Mar. 9, 2007, a continuation-in-part of Ser. No. 11/649,873 entitled A system of calibrating physicians' practices of medicine filed Jan. 5, 2007, a continuation-in-part of Ser. No. 11/637,662 entitled A vital hierarchy of data on diseases filed Dec. 13, 2006, a continuation-in-part of Ser. No. 11/599,847 entitled A hybrid intelligence in medicine filed Nov. 16, 2006, a continuation-in-part of Ser. No. 11/431,046 entitled A system of health-care information management filed Nov. 2, 2006, a continuation-in-part of Ser. No. 11/543,895 entitled Vital elements of speech recognition filed Oct. 6, 2006, a continuation-in-part of Ser. No. 11/523,945 entitled The networking of digital health information filed Sep. 21, 2006, a continuation-in-part of Ser. No. 11/510,820 entitled Words for managing health and health-care information filed Aug. 28, 2006, a continuation-in-part of Ser. No. 11/477,121 entitled the Medical Vocabulary Templates in Speech Recognition filed Jun. 29, 2006, a continuation-in-part of Fidelity of physicians' thoughts to digital data conversions filed Jan. 9, 2006, a continuation-in-part of Ser. No. 11/114,763 entitled A system of influencing health-care utilizations filed Apr. 27, 2005, a continuation-in-part of Ser. No. 11/196,823 entitled Routing of health information files filed Aug. 4, 2005, a continuation-in-part of Ser. No. 11/973,866 entitled An intelligent system of speech recognizing physicians' data, a continuation-in-part of Ser. No. 11/293,689 entitled A system of conserving health-care buyers' resources filed Dec. 5, 2005, a continuation-in-part of Ser. No. 11/150,878 entitled Physicians' optimal management of health information filed Jun. 13, 2005 (abandoned), a continuation-in-part of Ser. No. 11/074,236 entitled A system of management of health-care resources filed Mar. 7, 2005 and a continuation-in-part of Ser. No. 11/022,410 entitled Physicians' way of information productions filed Dec. 27, 2004, and a continuation-in-part of Ser. No. 11/059,088 entitled the Consumers-buyers-physicians health-care filed Feb. 16, 2005 (abandoned) which are pending.

### FIELD OF INVENTION

Computer-assisted system and method for managing health and health-care.

### BACKGROUND OF THE INVENTION

The present invention further improves or makes said pending patents including said application Ser. No. 11/114,763—details cited in Ser. No. 11/114,763—and one patent U.S. Pat. No. 6,132,218 granted to this physician applicant more intelligent and versatile to enable physicians and patients to overcome the current health-care crisis people are facing so that the quality of health-care and standard of living in America and the world are immensely improved and millions of lives are saved.

Furthermore, the present invention uniquely provides the only and fastest means for implementing said solution, and the most cost-effective, optimally and only-effective and realistic means for solving said crisis and, therefore, the objectives of the present invention are to fulfill the destiny of the American health-care system in the present century and beyond.

### SUMMARY OF THE INVENTION

The present invention provides a system and method for expressing, associating and interacting individual groups of diagnoses, chief complaints and related affecting organs, parts and anatomical sites of humans and related diagnoses and descriptions and illustrations of individual diseases, disorders and illnesses affecting organs, parts and anatomical sites of humans and related chief complaints, differential diagnoses, reviews of systems, physical examinations, information and data on health, health-care, health-care services, organs and anatomical sites and parts of humans and physicians' practices with individual specific interactive diagnoses, chief complaints, differential diagnoses, reviews of systems, physical examinations and related information and data on diseases and disorders, health, health-care, health-care services, organs and anatomical sites and parts of humans displayed on Web pages using systems of individual interactive templates, drop-down lists and panels associating with said individual by physicians and patients.

### DESCRIPTION OF THE PREFERRED EMBODIMENTS

The present invention provides, as described in said pending patent applications, the innovative computer programs and software coupled to Java Script, AJAX, PHP, HTML, XHTML, a SQL Server and a Web browser in a computer server or servers to create individual databases and/or individual compiled or pooled databases comprising diagnoses, individual groups of diagnoses, related diagnoses, syndromes and descriptions and illustrations of individual diseases, disorders and illnesses; organs, parts and anatomical sites, representations and illustrations of humans, chief complaints including signs and symptoms relating to individual diagnoses, individual groups of diagnoses, differential diagnoses, family histories, genetics, immunizations, laboratories, imaging, body fluid tests and tissues examinations, assessment and plan, medications, treatments, procedures, surgeries, recommendations, guidelines, referrals, follow-ups, organs and anatomical sites and parts of humans and information and data on physicians' practices and to create or effect the system, methods and processes of the present invention.

The present invention also provides a process for using said computer scripting languages and innovative computer programs and software to communicate with and command said SQL Server and a process for using said computer scripting languages and innovative computer programs and software to generate, expand and manage information and data in said databases in and manage by said SQL Server and a process for using said computer scripting languages and innovative computer programs and software to generate, relate and manage health, health-care and health-care-service information and data and the health, health-care and health-care-services information and data products and outcomes of the generations, relations, managements and uses of said information and data in the databases which are submitted, stored, related, compiled or pooled in said databases in and manage by said SQL Server. Other computer programs and software used by the present invention are noted infra.

The present invention and said pending patents provide information and data individual diagnoses, individual groups of diagnoses, differential diagnoses, family histories, genetics, immunizations, laboratories, imaging, body fluid tests and tissues examinations, assessment and plan, medications, treatments, procedures, surgeries, recommendations, guidelines, referrals, follow-ups, organs and anatomical sites and parts of humans and information and data on physicians' practices, etc. use by physicians of about 85 medical and surgical specialties and practices to be created, submitted, scanned, related and stored in the databases in and manage by said SQL server in said computer servers.

Any and all words, terms, headings, headers and items in Arial font infra represent interactive words, terms, headings, headers and items with the contents infra on Web pages and with physicians or patients who can use individual drop-down lists, individual templates and/or individual panels of diagnoses, syndromes, descriptions and illustrations of individual diseases, disorders and illnesses affecting organs, parts and anatomical sites of humans and chief complaints, differential diagnoses, reviews of systems, physical examinations, said information and data on health, health-care, health-care services, organs and anatomical sites and parts of humans and physicians' practices, etc.

Further to supra, for example, as applicable to Chief Complaints in all Web pages, Palliative Provocative Quality Region Severity Temporal are interactive words and terms producing drop-down lists of pertinent information and data which are viewed and used by physicians and patients on and relating to Chief Complaints.

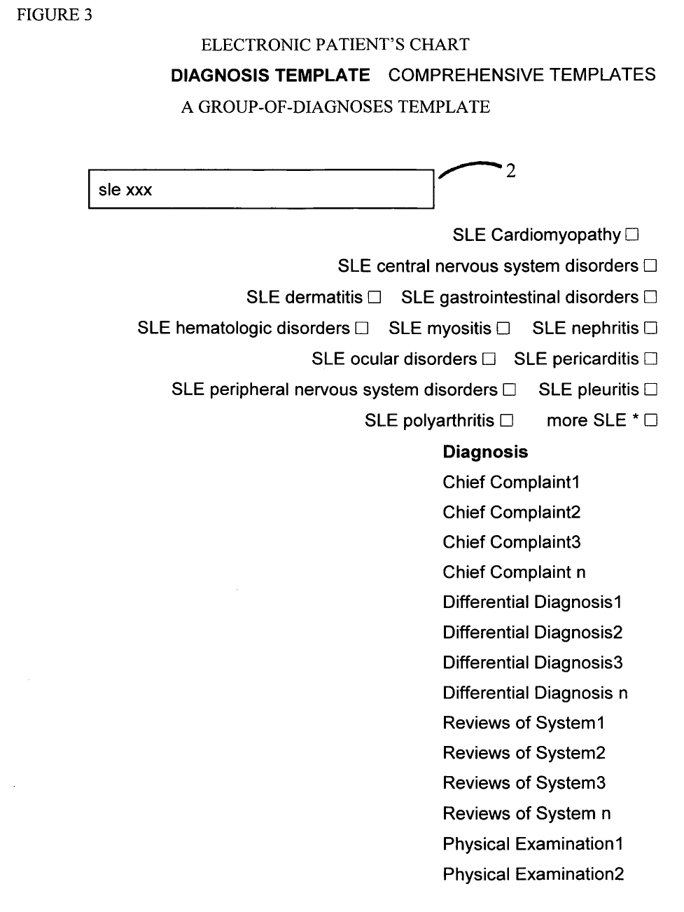

Further to supra, the system of templates comprising words and terms of information and data infra associating with boxes □ in the FIGS. 3, 4, 5 and 6 represents one of the preferred embodiments of the interactive templates comprising diagnoses, chief complaints, descriptions and illustrations of individual diseases, disorders and illnesses affecting organs, parts and anatomical sites of humans and related chief complaints, differential diagnoses, reviews of systems, physical examinations, information and data on health, health-care, health-care services, organs and anatomical sites and parts of humans and physicians' practices, family histories, genetics, immunizations, laboratories such as, but not limited to, imaging, body fluid tests and tissues examinations, assessment and plan, medications, treatments, procedures, surgeries, recommendations, guidelines, referrals and follow-ups, for physicians and patients, for example, to check or uncheck said boxes, as taught in said pending patent applications and as commonly seen and used for interactions between humans and computer and being provided by the present invention and said pending patent applications to generate, create, manipulate, relate, modify and/or edit and/or enter and store information and data in the databases in and manage by the SQL Server infra on and relating to said diagnoses, syndromes, descriptions and illustrations of individual diseases, disorders and illnesses affecting organs, parts and anatomical sites of humans and chief complaints, differential diagnoses, reviews of systems, physical examinations, information and data on health, health-care, health-care services, organs and anatomical sites and parts of humans and physicians' practices, etc. Further to supra, the present invention also provides a system of drop-down lists and panels for supra to achieve the goals and objectives of the present invention.

An example representing thousands of examples of the systems in the claims infra and the present invention wherein SQL database or databases herein comprising information and data on individual groups of diagnoses of diseases, disorders and illnesses affecting individual organs, parts and/or anatomical sites of humans comprises SQL database or databases on all diagnoses of diseases, disorders and illnesses affecting individual organs, parts and/or anatomical sites of humans, the human lumbosacral vertebrae—an organ, a part and/or an anatomical site of humans—can be affected diseases, disorders and illnesses such as, but not limited to, stresses and strains, repetitive strain injuries, cumulative trauma disorders, degenerative diseases, rheumatologic diseases such as rheumatoid arthritis and ankylosing spondylitis, congenital disorders; metabolic diseases, drugs, primary and secondary neoplasms, autoimmune diseases, hematologic and infectious diseases, etc. individual displays of individual interactive compositions of all diagnoses of diseases and disorders affecting individual organs, parts and/or anatomical sites of humans on said Web pages with individual specific diagnoses, differential diagnoses, reviews of systems, physical examinations and related information and data on diseases and disorders, health, health-care, health-care services, organs and anatomical sites and parts of human displayed on Web pages wherein said word and terms, organs and anatomical sites and/or parts of human are enabled to interactive with physicians and patients using said individual diagnoses, syndromes and/or descriptions and relating individual differential diagnoses, reviews of systems, physical examinations, information and data on health, health-care, health-care services and physicians' practices on said Web pages wherein said associations are expressed to, viewed and interactive with said physicians and patients in a network or networks of computers, portable and wireless electronic communication devices and said computer server or servers to enhance or optimize the accuracy of the recording of said information and data.

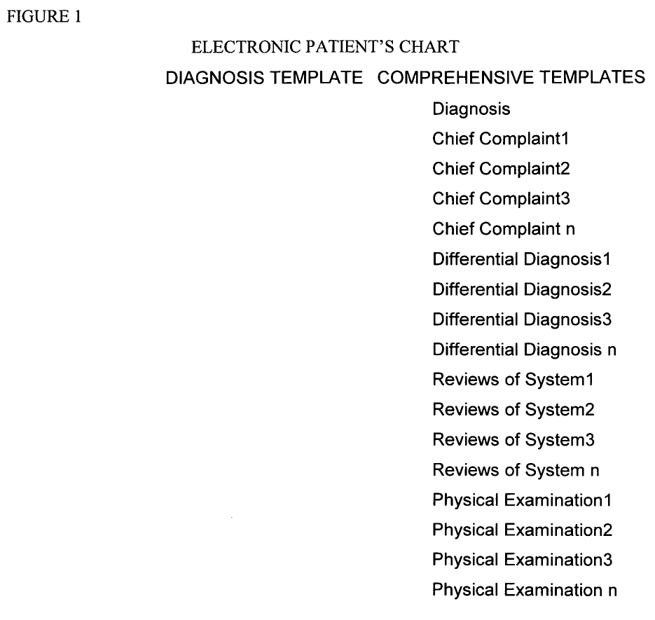

FIGS. 1-10 infra are most-simplified schematic representations of the preferred embodiments of the present invention and said pending patents wherein said schematic representations without all other relevant presentations appearing on Web pages enabled by a Web browser use by physicians and patients using computers, mobile and wireless communication devices to access said information and data in and manage by said SQL Server in said computer server or servers in a network or networks infra.

FIG. 1—a schematic representation of a Web page of individual patients' electronic charts comprising information and data on health, health-care and health-care services.

An example of thousands of examples of the system in the claims infra wherein said SQL database or databases comprising information and data on individual groups of diagnoses of diseases, disorders and illnesses affecting individual organs, parts and/or anatomical sites of humans comprises SQL database or databases on individual groups of diagnoses of diseases, disorders and illnesses affecting individual systems of organs, parts and/or anatomical sites of humans, using a systemic disease—SLE—representing thousands human diseases, disorders and illnesses affecting organs, parts and/or sites of humans such as, but not limited to, musculoskeletal organ, lungs, kidneys, eyes, cardiovascular, gastrointestinal, integument, hematologic and nervous systems. Therefore, using SLE as an example, details of supra are such as, but not limited to, a group of diagnoses of diseases, disorders and illnesses SLE arthropathy, SLE cardiomyopathy, SLE central nervous system disorders, SLE dermatitis, SLE gastrointestinal disorders, SLE myositis, SLE nephritis, SLE ocular disorders and more SLE * represents a preferred embodiments of the present invention displaying individual interactive compositions of individual groups of diagnoses of diseases and disorders affecting organs, parts and/or anatomical sites of humans on said Web pages with individual specific diagnosis or diagnoses. Said preferred embodiment of the present invention also embodies related diagnoses, syndromes, descriptions and illustrations of diseases, disorders and illnesses, chief complaints, differential diagnoses, reviews of systems, physical examinations, family histories, genetics, immunizations, laboratories such as, but not limited to, imaging, body fluid tests and tissues examinations, assessment and plan, medications, treatments, procedures, surgeries, recommendations, guidelines, referrals and follow-ups.

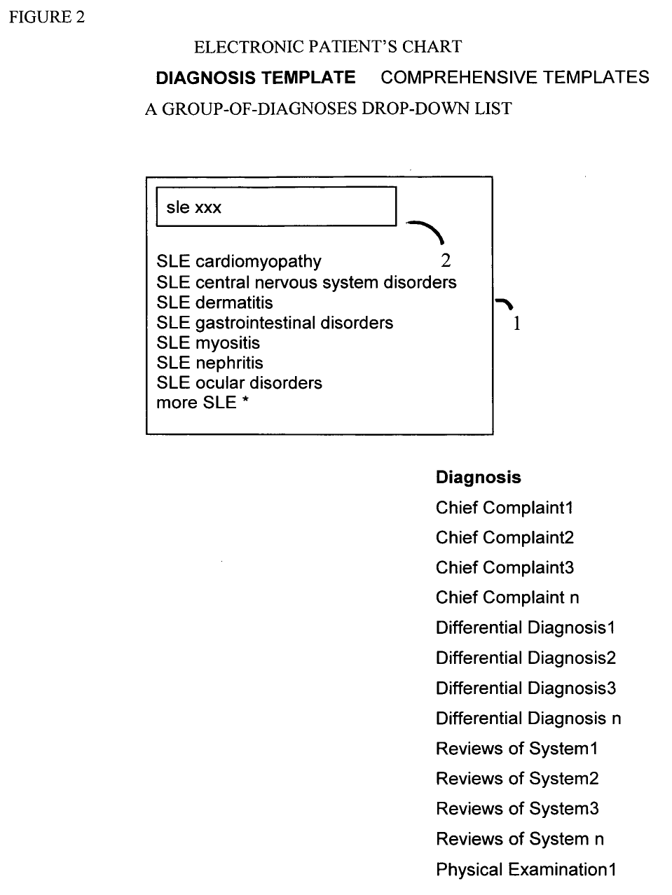

FIG. 2—A first example of the uses of individual drop-down lists in one of the preferred embodiments of the present invention, using said representative SLE—in the Arial font infra to represent interactive words and terms on Web pages—any physicians or patients can use drop-down lists of individual groups of diagnoses, individual drop-down lists 1 to search in query box 2 and retrieve and display individual interactive groups of diagnoses of diseases, disorders and illnesses affecting individual systems of organs, parts and anatomical sites of people or organs, parts and anatomical sites of humans. For this example, a physician of any specialty, specialties, practice or practices can click an interactive Diagnosis on individual representative Web pages in this figure to retrieve, display and use a drop-down list 1 and search and express a group of diagnoses on and relating to SLE by entering at least one alphabet of a word component, an alphanumerical or numerical component, a plurality of alphabets or alphanumerics, a space component or space components, a word component or a plurality of word components and a space component or a plurality of space components—in representative query box 2 wherein a word such as, but not limited to, sle (not case sensitive) and a space component between said SLE and a marker xxx—which are the most preferred embodiment of this process of the present invention as the speed, success of achieving said search and accuracy of said search of said one groups of diagnoses is expressed in said drop-down list 1 are optimized. In other words, by clicking Diagnosis, a physician of a certain specialty or specialties or a practice or practices can retrieve and display in a individual drop-down list 1 comprising all diagnoses on and relating to said physicians' specialties or practices. However, one of the preferred embodiments of the present invention, using the preferred method said physician—such as, but not limited to, a general practitioner or a psychiatrist, etc.—by entering a word component of a diagnosis which in this illustration is SLE—albeit SLE is an acronym—and a space component to search and retrieve and display individual interactive group of diagnoses on and relating to SLE affecting a system of organs, parts and anatomical sites as incompletely identified infra in said drop-down list 1—or in an interactive template and/or an interactive panel—the following schematics present in drop-down list 1 such as, but not limited to
SLE cardiomyopathy
SLE central nervous system disorders
SLE dermatitis
SLE gastrointestinal disorders
SLE myositis
SLE nephritis
SLE ocular disorders
more SLE *
   wherein more SLE* represents more diagnoses on and/or relating to SLE. Of course, in addition to supra, a plurality of word components and or a plurality of space components of diagnoses can also be used in any and all searches by physicians or patients. Furthermore, any patients can achieve supra like any physicians.

FIG. 3—further to FIG. 2, as individual templates—a representation of one of the preferred embodiments of the present invention wherein individual groups of diagnoses are searched, retrieved, expressed to, viewed and used by physicians as a template of interactive diagnoses on Web pages. In other words, by clicking Diagnosis or DIAGNOSIS TEMPLATE, this representative Web page as described in FIG. 2 supra, a physician of certain specialty or specialties or practice or practices can search using query box 2 as explained in FIG. 2 supra and retrieve and display in a template of diagnoses associating with individual interactive boxes □—or individual drop-down lists or panels—comprising a group of SLE diseases, disorders and illnesses affecting a system of organs, parts and anatomical sites or organs, parts and anatomical sites of humans such as, but not limited to
SLE Cardiomyopathy □ SLE central nervous system disorders □
SLE dermatitis □ SLE gastrointestinal disorders □
SLE hematologic disorders □ SLE myositis □
SLE nephritis □ SLE ocular disorders □ SLE pericarditis □
SLE peripheral nervous system disorders □ SLE pleuritis □
SLE polyarthritis □ more SLE * □
   wherein more SLE * □ represents more diagnoses on and relating to SLE. Furthermore, any patients can achieve supra like any physicians.

FIGS. 2, 3 and 4—one of the preferred embodiments of the present invention—as individual drop-down lists and/or individual templates, and/or panels (not shown)—is represented whereby clicking Diagnosis, for example, a rheumatologist or albeit less likely a patient retrieves or, in this representation, activates the interactive DIAGNOSIS TEMPLATE 1 comprising all topics in rheumatology—not shown in the figures—such as, but not limited to, Amyloidosis, Behcet's syndrome, Crystal arthropathies, Fibromyalgia, Infectious arthritis, Osteoarthritis, Rheumatoid arthritis, Rheumatic fever, Relapsing polychondritis, Sarcoidosis, Spondyloarthritides, Systemic lupus erythematosus, Vasculitis syndromes, Sjogren's syndrome which upon clicking on said individual topics, said rheumatologist can expand on, view and use all and related interactive information and data. However, as a example of one of the preferred embodiments of the present invention, if said physician uses a query box 2 wherein a word such as, but not limited to, viral and a space component represents in these figures as a space between said one word and a marker xxx, a group of diseases on or relating to said Diagnosis represent in FIGS. 2 and 3 on and relating to SLE affecting a system of organs, parts and anatomical sites of humans or organs, parts and anatomical sites of humans are retrieved, displayed and used by said physician:
SLE cardiomyopathy
SLE central nervous system disorders
SLE dermatitis
SLE gastrointestinal disorders
SLE myositis
SLE nephritis
SLE ocular disorders
more SLE *

Said preferred embodiment provides also for other diagnoses and syndromes and related diagnoses and descriptions and illustrations of individual diseases, disorders and illnesses affecting organs, parts and anatomical sites of humans and related chief complaints, differential diagnoses, reviews of systems, physical examinations, information and data on health, health-care, health-care services, organs and anatomical sites and parts of humans and physicians' practices. Further more, said preferred embodiments associate said individual interactive templates, drop-down and/or panels with individual specific diagnoses, chief complaints, differential diagnoses, reviews of systems, physical examinations and related information and data on diseases and disorders, health, health-care, health-care services, organs and anatomical sites and parts of humans displayed on Web pages.

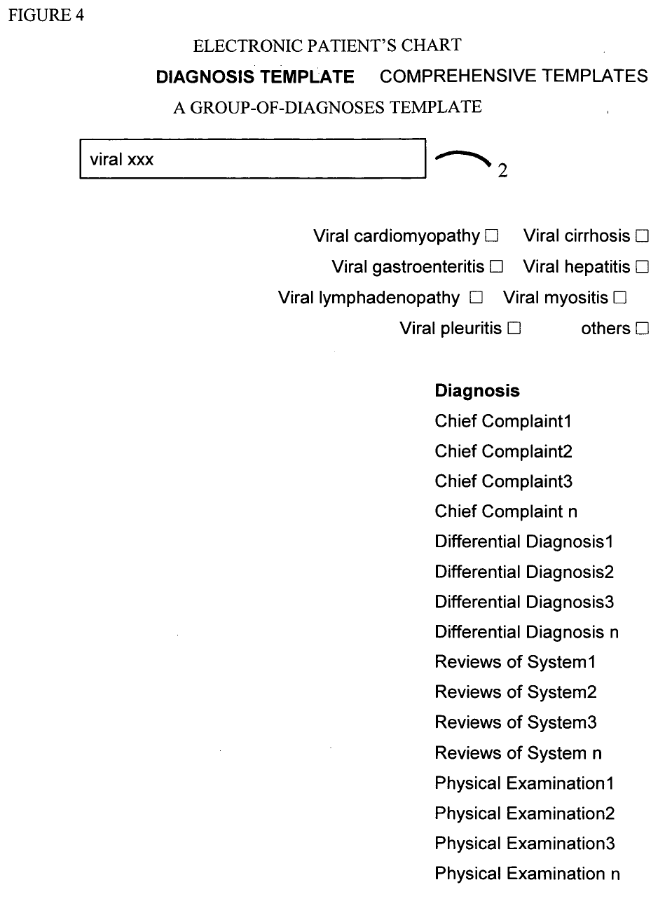

FIGS. 3 and 4—further to FIG. 2, a process for using a word, a numerical or an alphanumerical component or a plurality of word components, numerical components or alphanumerics components and a space component or a plurality of space components of a diagnosis in query box 2 to express—in individual templates although drop-down lists and/or panels can be provided—individual groups of diagnoses of diseases, disorders and illnesses affecting individual systems of organs, parts and anatomical sites of people or individual organs, parts and anatomical sites of humans. Further to supra, said individual expressions of said individual templates comprising individual groups of diagnoses are associated with individual diagnoses, chief complaints, differential diagnoses, reviews of systems, physical diagnoses, syndromes, descriptions and illustrations of diseases, disorders and illnesses, chief complaints, differential diagnoses, reviews of systems, physical examinations, family histories, genetics, immunizations, laboratories such as, but not limited to, imaging, body fluid tests and tissues examinations, assessment and plan, medications, treatments, procedures, surgeries, recommendations, guidelines, referrals and follow-ups. Said method, therefore, enables any physicians or patients to toggle back and forth between said Web pages.

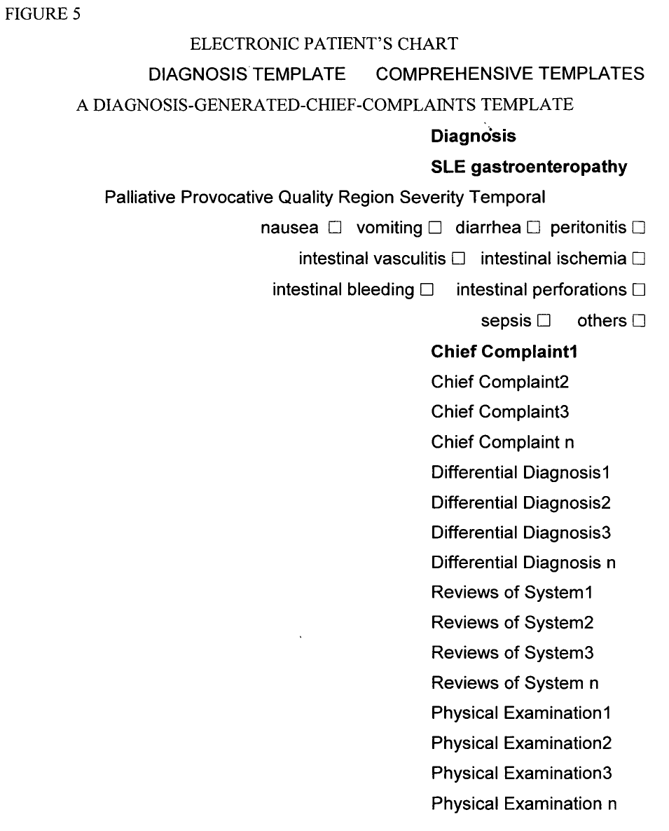

FIG. 5—a process for expressing signs and symptoms and related of chief complaints relating to individual diagnoses of diseases, disorders and illnesses affecting individual systems of organs, parts and anatomical sites of humans or individual organs, parts and anatomical sites of humans by physicians or patients expressing individual diagnoses or individual diagnoses of individual groups of diagnoses of diseases, disorders and illnesses. For example, any physicians can click Diagnosis and as taught supra, retrieve and choose SLE gastroenteropathy and then click Chief Complaint 1 to retrieve, display an interactive template of signs and symptoms on and relating to SLE gastroenteropathy as briefly and schematically represented in this figure.

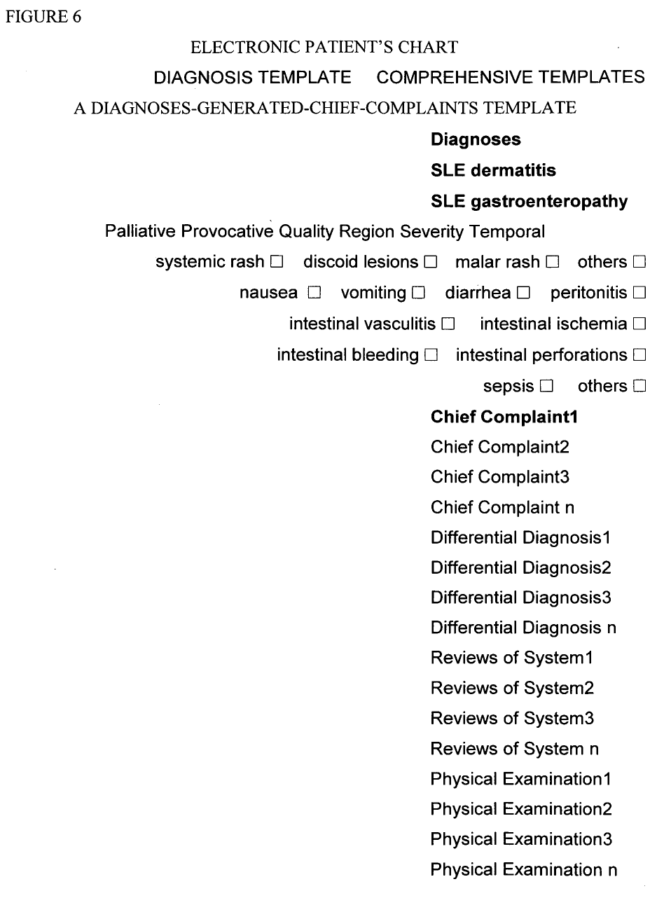

FIG. 6—a process for using plurality of word components and plurality of space components of signs and symptoms and related of chief complaints on and relating to individual diagnoses to express individual groups of diagnoses of diseases, disorders and illnesses affecting individual systems of organs, parts and anatomical sites of people or individual organs, parts and anatomical sites of humans associating with chief complaints, differential diagnoses, reviews of systems, physical examinations and information and data on diseases and disorders, health, health-care, health-care services, and organs, anatomical sites and parts, representations and illustrations of humans and physicians' practices on Web pages.

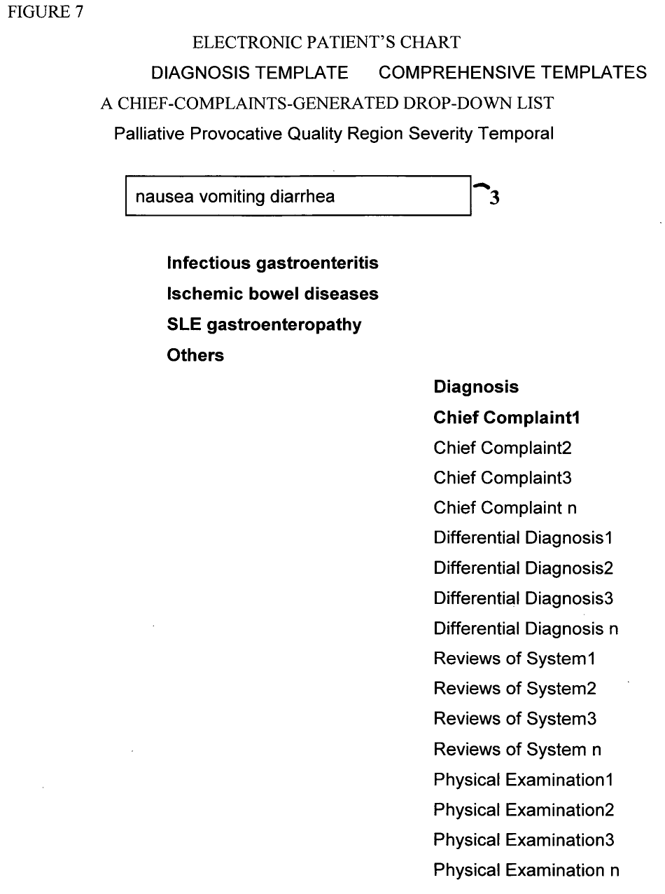

FIG. 7—one of the preferred embodiments of the present invention—a process for using a word component or plurality of word components and a space components or plurality of space components of signs and symptoms on and relating to diagnoses in query box 3 to search and express individual interactive groups of diagnoses of diseases, disorders and illnesses affecting individual systems of organs, parts and anatomical sites of people or individual organs, parts and anatomical sites of humans associating with individual diagnoses on Web pages. Further to supra, FIG. 7 also shows one of the preferred embodiments of the present invention comprises a process for using a word component or plurality of word components and a space component or plurality of space components of signs and symptoms on and relating to individual diagnoses to express individual groups of diagnoses of diseases, disorders and illnesses affecting individual systems of organs, parts and anatomical sites of people or individual organs, parts and anatomical sites of humans associating with chief complaints, differential diagnoses, reviews of systems, physical examinations and information and data on diseases and disorders, health, health-care, health-care services, and organs, anatomical sites and parts, representations and illustrations of humans and physicians' practices on Web pages.

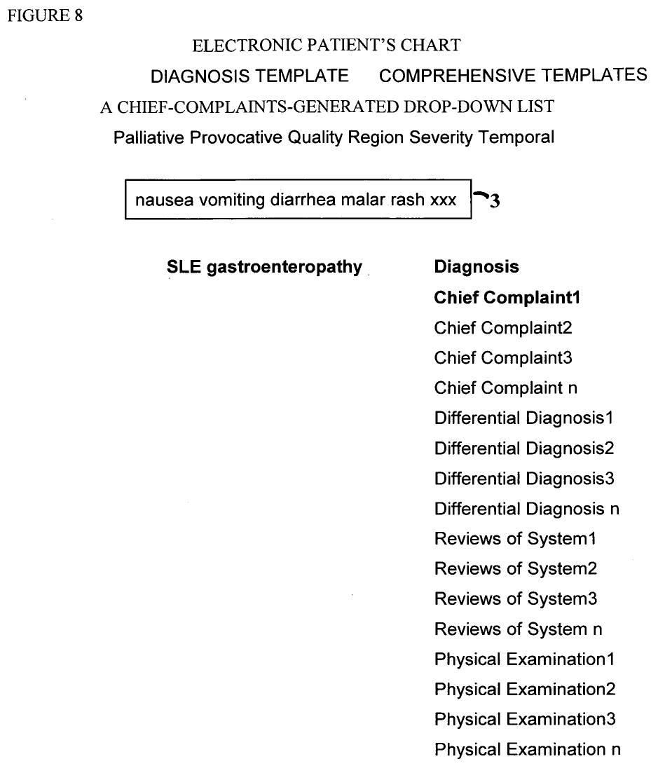

FIG. 8—further to supra in FIG. 7—one of the preferred embodiments of the present invention—a process for using a plurality of additional word components and a plurality of additional space components of signs and symptoms to narrow the searches and narrowly expressing—in query box 3 (representing said query box 3 after “malar rash” was added to said word and said space components in said query box 3 in said FIG. 7)—individual groups of diagnoses to individual diagnoses of diseases, disorders and illnesses being represented in FIG. 8 by SLE gastroenteropathy. Said expressions to physicians or patients can be associated with diagnoses, chief complaints, differential diagnoses, reviews of systems, physical examinations differential diagnoses, reviews of systems, physical examinations, family histories, genetics, immunizations, laboratories such as, but not limited to, imaging, body fluid tests and tissues examinations, assessment and plan, medications, treatments, procedures, surgeries, recommendations, guidelines, referrals and follow-ups and physicians' practices on Web pages.

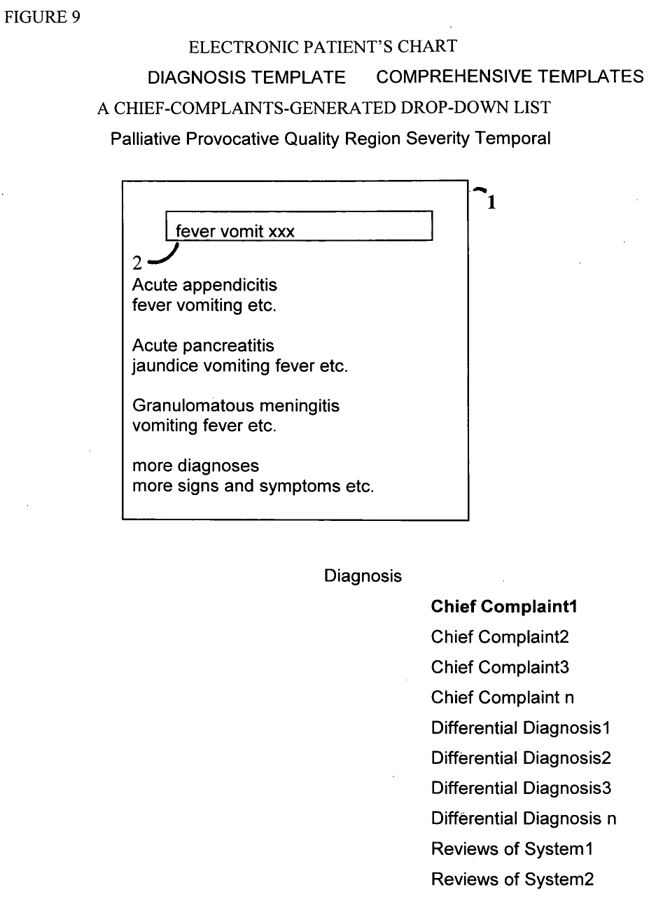

FIG. 9—further to supra—one of the preferred embodiments of the present invention—a process for using a word component or a plurality of word components and a space components or a plurality of space components of signs and symptoms relating to diagnoses in query box 2 to search and express said individual groups of diagnoses and relating signs and symptoms which represent chief complaints and all its elements such as, but not limited to, palliatives, provocatives, quality, regions, severity and temporal factor.

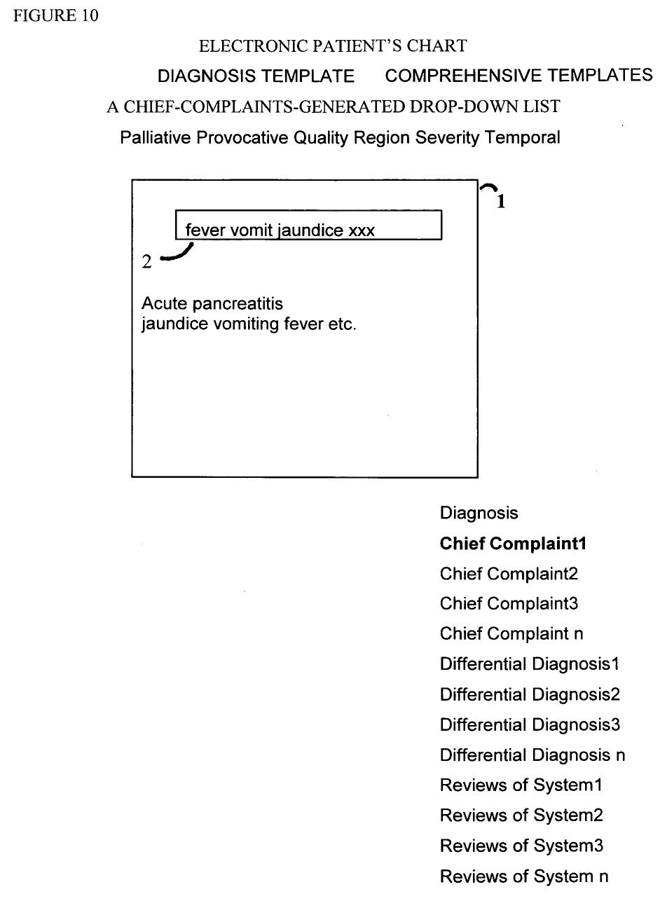

FIG. 10—further to supra in FIG. 9—one of the preferred embodiments of the present invention—a process for using a plurality of additional word components and a plurality of additional space components of signs and symptoms of chief complaints to narrow the searches and narrowly expressing—in query box 2 (representing said query box 2 after “jaundice” was added to said word and said space components in said query box 2 in said FIG. 9)—individual groups of diagnoses to individual diagnoses of diseases, disorders and illnesses being represented in FIG. 10 by Acute pancreatitis and relating signs and symptoms represent by jaundice vomiting fever etc.

In other words, for example, by clicking Chief Complaint 1 in FIG. 9 a physician can retrieve and display in an individual drop-down list 1 comprising a query box 2 wherein said physician can enter one alphabet of a word component, an alphanumerical or numerical component, a plurality of alphabets or alphanumerics, a space component or space components, a word component, a space component, a plurality of word components and a plurality of space components in representative query box 2 which are the most preferred embodiment of this process of the present invention as the speed, success of achieving said search and accuracy of said search of said diagnoses—related diagnoses as in said individual groups of diagnoses described here and supra and/or unrelated diagnoses and related chief complaints being searched in and retrieved from said SQL database in and manage by said SQL Server are expressed in said drop-down list 1 are optimized. Into query box 2, fever vomiting are two words of said signs and symptoms of chief complaints and expressed by AJAX and related computer programs and software are the following representative pairs—of many pairs or possibilities—of diagnosis and related signs and symptoms which are present in said drop-down list 1—and all individual words and terms use in medicine and/or surgery by physicians are interactive with said physician and interactive headings as described infra as one of the preferred embodiments of the present invention—such as, but not limited to
Acute appendicitis
fever vomiting etc.
Acute pancreatitis
jaundice vomiting fever etc.
Granulomatous meningitis
vomiting fever etc.
more diagnoses
more signs and symptoms etc.
   wherein said etc. represents more signs and symptoms relating to preceding diagnosis. For example, said physician can merely view to learn from said expression and/or can click any said words and terms such as, but not limited to Acute appendicitis, jaundice, vomiting, fever to associate said clicks with the Diagnosis and/or Chief complaint on said Web pages as taught in said pending patent applications to produce outcomes which are submitted, related and stored in said SQL database or databases as taught herein and earlier.

However, in FIG. 10, one of the preferred embodiments of the present invention, using the preferred method said physician—such as, but not limited to, a general practitioner or a psychiatrist, etc.—by entering another space component and a word component of signs and symptoms which is jaundice to narrow the search and retrieve and display a diagnosis which is Acute pancreatitis and relating signs and symptoms which are both viewed and used by said physician as taught supra. Said display in said FIG. 9 can be returned to the viewing screen by deleting said jaundice.

Further to supra, FIGS. 1-10 represent yet one of the preferred embodiments of the present invention which further innovates the versatile system of templates of pending patent application Ser. No. 12/381,654 filed Mar. 16, 2009 entitled the Adaptable compositions of health information which is represent herein as COMPREHENSIVE TEMPLATES. As one of the preferred embodiments of the present invention, a method for associating and effecting the interactions of a system of templates of words and terms representing diagnoses in individual groups of diagnoses of diseases, disorders and illnesses affecting individual systems of organs, parts and anatomical sites of humans or individual organs, parts and anatomical sites of humans and related diagnoses, syndromes, descriptions and illustrations of diseases, disorders and illnesses, chief complaints, differential diagnoses, reviews of systems, physical examinations, family histories, genetics, immunizations, laboratories such as, but not limited to, imaging, body fluid tests and tissues examinations, assessment and plan, medications, treatments, procedures, surgeries, recommendations, guidelines, referrals and follow-ups. Said method, therefore, enables any physicians or patients to toggle back and forth between said Web pages represent herein by a figure and said COMPREHENSIVE TEMPLATES. In other words, by clicking COMPREHENSIVE TEMPLATES in the figure, any physicians can retrieve interactive templates comprising words and terms and associating interactive boxes □ on diagnoses, syndromes, descriptions and illustrations of diseases, disorders and illnesses, chief complaints, differential diagnoses, reviews of systems, physical examinations, family histories, genetics, immunizations, laboratories such as, but not limited to, imaging, body fluid tests and tissues examinations, assessment and plan, medications, treatments, procedures, surgeries, recommendations, guidelines, referrals and follow-ups and physicians' practices to serve to modify, edit, add and improve said information and data on said categories of health, health-care and health-care services in said databases in and manage by said SQL server in said computer server or servers.

In said preferred embodiments of the present invention, the present invention provides for supra to be related or associated with individual diagnoses, chief complaints, differential diagnoses, reviews of systems, physical examinations differential diagnoses, reviews of systems, physical examinations, family histories, genetics, immunizations, laboratories such as, but not limited to, imaging, body fluid tests and tissues examinations, assessment and plan, medications, treatments, procedures, surgeries, recommendations, guidelines, referrals, follow-ups, organs and anatomical sites and parts and representations and illustrations of humans and physicians' practices displayed on Web pages.

Corollary, although not shown in the figures, a process for using words, terms, one alphabet or a plurality of alphabets, alphanumerics and/or numerics of a word component, word components, a space component and/or a plurality of space components and various preferred embodiments described herein to express individual groups of diagnoses of diseases, disorders and illnesses affecting individual systems of organs, parts and anatomical sites of people or individual organs, parts and anatomical sites of humans and individual related diagnoses, syndromes, descriptions and illustrations of diseases, disorders and illnesses, chief complaints, differential diagnoses, reviews of systems, physical examinations, family histories, genetics, immunizations, laboratories such as, but not limited to, imaging, body fluid tests and tissues examinations, assessment and plan, medications, treatments, procedures, surgeries, recommendations, guidelines, referrals and follow-ups.

Although not shown in all said figures, it is to be understood that whenever and wherever said templates are used, the present invention can provide a system of drop-down lists and/or panel as one of the preferred embodiments of the present invention.

It is to be understood that said interactive templates, drop-down lists or menus, panels, illustrations, graphics, representations and figurines are provided by the present invention and said pending patents and can be clicked or touched to present templates, pop-up and/or drop-down lists and/or menus of words, terms, phrases, sentences, texts, synonyms, acronyms, texts, numbers, graphics, and word and term headers or headings comprising information and data on and relating to said diagnoses on diseases, disorders, health, health-care and health-care services viewable and useable by said physicians and/or patients. Furthermore, in the preferred embodiments of said patent applications and the present invention, said word and term headers comprise diagnoses, syndromes, descriptions and illustrations of diseases, disorders and illnesses, chief complaints, differential diagnoses, reviews of systems, physical examinations, family histories, genetics, immunizations, laboratories such as, but not limited to, imaging, body fluid tests and tissues examinations, assessment and plan, medications, treatments, procedures, surgeries, recommendations, guidelines, referrals and follow-ups.

As taught in pending patent application Ser. No. 12/592,714 entitled Health-care Exchange IV filed Dec. 2, 2009, it is to be noted herein also that the present invention repeat one preferred embodiment of said invention wherein a process for locating or positioning—wherever feasible, achievable, workable or practicable—interactive functions, panels and tools and information and data health, health-care, health-care services and communications to physicians and patients in the right half or area of said viewing screens including touch-enabled screens or touchscreens of computers, mobile and wireless communication devices.

The present invention provides a system and a method for associating and interacting said information and data in individual templates, individual drop-down lists as described supra and/or individual panels, graphics, illustrations and representations such as, but not limited to, U.S. Pat. No. 6,132,218 (not shown herein) on diagnoses, individual groups of diagnoses affecting systems of organs, parts and anatomical sites of humans or individual organs, parts and anatomical sites of humans and related diagnoses and descriptions and illustrations of individual diseases, disorders and illnesses affecting organs, parts and anatomical sites of humans and chief complaints, differential diagnoses, reviews of systems, physical examinations, information and data on health, health-care, health-care services, organs and anatomical sites and parts of humans and physicians' practices with individual specific interactive diagnoses, chief complaints, differential diagnoses, reviews of systems, physical examinations and related said information and data on diseases and disorders, health, health-care, health-care services, organs and anatomical sites and parts of humans displayed on Web pages as taught supra and by said pending patent applications. Furthermore, one of the preferred embodiments of the present invention also creates, submits, scans, relates and stores said information and data and their derivatives and outcomes in said SQL Server wherein searches, retrievals, displays and uses of said information and data, derivatives and outcomes in said associations and interactions to physicians and patients are effected.

The method, processes, systems, protocols, managements, matters, functions, searches, information and data, products and outcomes and related and derivatives of the present invention are implemented and effected by the innovative computer software and programs invented and developed by the present patent applicant which were filed with and are stored in the Library of Congress in Washington, D.C. The present invention uses also the commercially available computer software (plural), programs and computer languages such as, but not limited to, those made and sold by Microsoft Corporation such as, but not limited to, Microsoft Windows Server, SQL such as, but not limited to Microsoft SQL Server, MySQL and the like, Internet Explorer, Web browsers, Web server, Apache, Microsoft IIS, Visual Studio and .Net, Microsoft software including Notepad, Wordpad and .txt programs and their derivatives and the like and related and their database, databases and derivatives, other computer corporations' and companies' programs, languages, codes and databases and their derivatives which are commonly and routinely used by computer engineers and programmers such as, but not limited to, PHP, PERL, C languages, such as, but not limited to, C, C+, C++, C#, JAVA, Java Script, AJAX, HTML, XHTML and the like and related and their derivatives. Other security software are such as, but not limited to, encryption-decryption of the information and data infra and their derivatives and products, processes and software, Firewall, anti-viral and related, Secure Sockets Layer (SSL) or Transport Layer Security (TLS) and related and the like and their derivatives.

The standard commercial hardware and equipment being used in the TCP/IP networks and the like or equivalence such as, but not limited to, the Internet commerce are implemented and deployed per standard industrial practices and use hardware and equipment such as, but not limited to, computer servers and computers such as numerous HP and IBM servers, HP and Dell computers, Cisco routers and related, and various equipment including modems sold, lease, own and operate by cable companies such as, but not limited to, Time Warner and Optimum Online in New York, etc. Currently, HP ProLiant ML350 and ML110 Generation 4p Servers—see www.hp.com for details of the server hardware and internal design—and similar Dell server—see www.dell.com for details of the server hardware and internal design—used by the present patent applicant as the hardware wherein the computer programs and software(s) mentioned herein operate. It is obvious and known that with more extensive operations, requirements and equipment, server blades and various hardware and equipment configurations, virtual servers such as those sold by VMware, HP and IBM, and their derivatives being used by many large American corporations can and will be used to implement the present invention.

Consequent to the incorporations of said data and information using computer programs, software mentioned herein and the like, the products of said incorporations are stored in and retrieved from database or databases to be displayed on the viewing screens and comprehensible and use by patients and physicians.

It is obvious and understood that there are other commercially available computer programs and software and hardware and equipment which are not mentioned herein but can be used to support the present invention without departing from the spirit of and within the scope of the claims infra and present invention to achieve the goals and objectives of the present invention.

Although the preferred embodiments of this invention have been represented by figures embodying diagnoses and chief complaints, it is understood that the present invention also embodies all diagnoses, individual groups of diagnoses, syndromes and signs and symptoms affecting organs, parts and anatomical sites of humans, descriptions and illustrations of individual diseases, disorders and illnesses affecting organs, parts and anatomical sites of people and chief complaints, differential diagnoses, reviews of systems, physical examinations, information and data on health, health-care, health-care services, organs and anatomical sites and parts of humans and physicians' practices, family histories, genetics, immunizations, laboratories such as, but not limited to, imaging, body fluid tests and tissues examinations, assessment and plan, medications, treatments, procedures, surgeries, recommendations, guidelines, referrals and follow-ups, etc.

Further to supra, it is understood that not all diagnoses, chief complaints, etc. affecting organs and body parts are represented in said examples although the present invention provides for all diagnoses and related chief complaints whenever and wherever applicable in the practice of medicine and surgery by physicians. This understanding applies to all diagnoses, individual groups of diagnoses, syndromes and signs and symptoms affecting organs, parts and anatomical sites of humans, descriptions and illustrations of individual diseases, disorders and illnesses affecting organs, parts and anatomical sites of people and chief complaints, differential diagnoses, reviews of systems, physical examinations, information and data on health, health-care, health-care services, organs and anatomical sites and parts of humans and physicians' practices, family histories, genetics, immunizations, recommendations, referrals, follow-ups, laboratories and tests, etc.

Although the preferred embodiments of this invention have been described for people, it will be appreciated by those skilled in the art that adaptations and variations may be made to apply to other species, animals, biological entities or structures, infectious particles or structures, and machines without departing from the spirit of the invention and the scope of the claims.

Although the preferred embodiments of this invention have been described, it will be appreciated by those skilled in the art that adaptations and variations may be made without departing from the spirit of the invention and the scope of the claims.

1. A system for associating and interacting individual groups of diagnoses affecting organs, parts and anatomical sites of humans and related diagnoses and descriptions and illustrations of individual diseases, disorders and illnesses affecting organs, parts and anatomical sites of humans and related chief complaints, reviews of systems, physical examinations, organs and anatomical sites and parts of humans and physicians' practices, family histories, genetics, immunizations, laboratories, imaging, body fluid tests and tissues examinations, assessment and plan, medications, treatments, procedures, surgeries, recommendations, guidelines, referrals and follow-ups with individual specific diagnoses, chief complaints, differential diagnoses, reviews of systems, physical examinations, organs and anatomical sites and parts of humans and physicians' practices, family histories, genetics, immunizations, laboratories, imaging, body fluid tests and tissues examinations, assessment and plan, medications, treatments, procedures, surgeries, recommendations, guidelines, referrals and follow-ups, organs and anatomical sites and parts of humans displayed on Web pages wherein said individual groups of diagnoses and signs and symptoms affecting organs, parts and anatomical sites of people and related diagnoses, syndromes and descriptions and illustrations of individual diseases, disorders and illnesses affecting organs, parts and anatomical sites of people and related diagnoses, chief complaints, differential diagnoses, family histories, genetics, immunizations, laboratories, imaging, body fluid tests and tissues examinations, assessment and plan, medications, treatments, procedures, surgeries, recommendations, guidelines, referrals and follow-ups associating and interactive with individual specific diagnoses and signs and symptoms affecting organs, parts and anatomical sites of humans, descriptions and illustrations of individual diseases, disorders and illnesses affecting organs, parts and anatomical sites of people and chief complaints, reviews of systems, physical examinations, organs and anatomical sites and parts of humans and physicians' practices, family histories, genetics, immunizations, laboratories, imaging, body fluid tests and tissues examinations, assessment and plan, medications, treatments, procedures, surgeries, recommendations, guidelines, referrals and follow-ups, organs and anatomical sites and parts of humans and physicians' practices are created, submitted, scanned, related and stored in the databases in and manage by a SQL Server in a computer server or computer servers wherein said associations and updates are created, submitted, scanned, related and stored in the databases in and manage by said SQL Server wherein said individual groups of diagnoses and said diagnoses, syndromes and descriptions and illustrations of individual diseases, disorders and illnesses affecting organs, parts and anatomical sites of people and related diagnoses, chief complaints, differential diagnoses, reviews of systems, physical examinations, information and data on health, health-care, health-care services, organs and anatomical sites and parts of humans and physicians' practices are expressed to, viewed by, interactive with and used by physicians and patients using computers, portable and wireless electronic communication devices in a network or networks of said computers, portable and wireless electronic communication devices and said computer servers to enhance or optimize the accuracy of the recording of said information and data, to assist with and/or facilitate the medical decision makings and reduce or eliminate errors in decision makings of physicians and patients, to improve and increase the efficiency of the processes of generating and recording health and health-care information and data, to expedite the process or processes of entering and recording of said information and data into said database or databases by physicians and patients and to reduce the repetitive efforts of physicians' productions of same or similar said information and data and relating errors comprises:
a SQL database or SQL databases comprising individual diagnoses of diseases, disorders and illnesses;
a SQL database or SQL databases comprising individual diagnoses of diseases and disorders and relating diagnoses, syndromes and descriptions and illustrations of individual diseases, disorders and illnesses;
a SQL database or SQL databases comprising individual diagnoses of diseases and disorders affecting individual organs, parts and anatomical sites of humans;
a SQL database or SQL databases comprising individual groups of diagnoses of diseases and disorders affecting individual organs, parts and anatomical sites of humans;
a SQL database or SQL databases comprising individual groups of diagnoses of diseases and disorders affecting organs, parts and anatomical sites of humans;
a SQL database or SQL databases comprising diagnoses in individual groups of same, equivalent or similar diagnoses of diseases and disorders affecting organs, parts and anatomical sites of humans;
a SQL database or SQL databases comprising signs and symptoms relating to individual diagnoses of diseases, disorders and illnesses;
a SQL database or SQL databases comprising signs and symptoms relating to individual groups of diagnoses of diseases, disorders and illnesses affecting individual systems of organs, parts and anatomical sites of humans;
a SQL database or SQL databases comprising signs and symptoms relating to individual groups of diagnoses of diseases, disorders and illnesses affecting individual organs, parts and anatomical sites of humans;
a SQL database or SQL databases comprising individual compositions of descriptions and illustrations of individual diseases, disorders and illnesses affecting individual organs, parts and anatomical sites of humans;
a SQL database or SQL databases comprising individual compositions of descriptions and illustrations of individual diseases, disorders and illnesses affecting individual systems of organs, parts and anatomical sites of humans;
a SQL database or SQL databases comprising individual diagnoses and related diagnoses, syndromes and descriptions and illustrations of individual diseases, disorders and illnesses affecting organs, parts and anatomical sites of people and related chief complaints, differential diagnoses, family histories, genetics, immunizations, laboratories, imaging, body fluid tests and tissues examinations, assessment and plan, medications, treatments, procedures, surgeries, recommendations, guidelines, referrals, follow-ups, organs and anatomical sites and parts of humans and physicians' practices;
individual interactive of diagnoses of diseases and disorders affecting individual organs, parts and anatomical sites of humans;
individual interactive groups of diagnoses of diseases and disorders affecting organs, parts and anatomical sites of humans;
individual interactive groups of diagnoses of diseases and disorders affecting individual systems of organs, parts and anatomical sites of humans;
individual interactive groups of same, equivalent or similar diagnoses of diseases and disorders affecting organs, parts and anatomical sites of humans;
individual interactive groups of same, equivalent or similar diagnoses of diseases and disorders affecting individual systems of organs, parts and anatomical sites of humans;
individual interactive diagnoses and syndromes of individual diseases, disorders and illnesses affecting individual organs, parts and anatomical sites of humans;
individual interactive diagnoses and syndromes of individual diseases, disorders and illnesses affecting individual systems of organs, parts and anatomical sites of humans;
interactive signs and symptoms relating to individual diagnoses of diseases, disorders and illnesses;
interactive signs and symptoms relating to individual groups of diagnoses of diseases, disorders and illnesses affecting individual systems of organs, parts and anatomical sites of humans;
interactive signs and symptoms relating to individual groups of diagnoses of diseases, disorders and illnesses affecting individual organs, parts and anatomical sites of humans;
individual interactive descriptions and illustrations of individual diseases, disorders and illnesses affecting individual organs, parts and anatomical sites of humans;
individual interactive descriptions and illustrations of individual diseases, disorders and illnesses affecting individual systems of organs, parts and anatomical sites of humans; and
individual interactive diagnoses, groups of diagnoses, differential diagnoses, reviews of systems, physical examinations, family histories, genetics, immunizations, laboratories, imaging, body fluid tests and tissues examinations, assessment and plan, medications, treatments, procedures, surgeries, recommendations, guidelines, referrals, follow-ups, organs and anatomical sites and parts of humans and physicians' practices associating and interactive with individual specific diagnoses, chief complaints, differential diagnoses, reviews of systems, physical examinations and related information and data on diseases and disorders, health, health-care, health-care services, organs, parts and anatomical sites of humans displaying on said Web pages.

2. The system for associating and interacting individual groups of diagnoses affecting organs, parts and anatomical sites of people and related diagnoses, syndromes and descriptions and illustrations of individual diseases, disorders and illnesses affecting organs, parts and anatomical sites of people and chief complaints, differential diagnoses, reviews of systems, physical examinations, information and data on health, health-care, health-care services, organs and anatomical sites and parts of humans and physicians' practices with individual specific diagnoses, chief complaints, differential diagnoses, reviews of systems, physical examinations and related information and data on diseases and disorders, health, health-care, health-care services, organs and anatomical sites and parts of humans displayed on Web pages according to claim 1 comprises a system of drop-down lists comprising said individual groups of diagnoses; said related diagnoses, syndromes and descriptions and illustrations; said chief complaints; said differential diagnoses; said reviews of systems; said physical examinations; and said information and data on health, health-care, health-care services, organs and anatomical sites and parts of humans and physicians' practices relating to and interacting with individual specific diagnoses, chief complaints, differential diagnoses, reviews of systems, physical examinations and related information and data on diseases and disorders, health, health-care, health-care services, organs and anatomical sites and parts of humans displayed on Web pages.

3. The system of drop-down lists according to claim 2 include individual panels comprise generated, scanned, related, compiled and updated information and data on individual groups of diagnoses; said related diagnoses, syndromes and descriptions and illustrations; said chief complaints; said differential diagnoses; said reviews of systems; said physical examinations; and said information and data on health, health-care, health-care services, organs and anatomical sites and parts of humans and physicians' practices.

4. The system of drop-down lists according to claim 2 comprise generated, scanned, related, compiled and updated information and data on individual groups of diagnoses; said related diagnoses, syndromes and descriptions and illustrations; said chief complaints; said differential diagnoses; said reviews of systems; said physical examinations; and said information and data on health, health-care, health-care services, organs and anatomical sites and parts of humans and physicians' practices.

5. The system for associating and interacting individual groups of diagnoses affecting organs, parts and anatomical sites of people and related diagnoses, syndromes and descriptions and illustrations of individual diseases, disorders and illnesses affecting organs, parts and anatomical sites of people and chief complaints, differential diagnoses, reviews of systems, physical examinations, information and data on health, health-care, health-care services, organs and anatomical sites and parts of humans and physicians' practices with individual specific diagnoses, chief complaints, differential diagnoses, reviews of systems, physical examinations and related information and data on diseases and disorders, health, health-care, health-care services, organs and anatomical sites and parts of humans displayed on Web pages according to claim) comprises a system of individual interactive templates comprising said individual groups of diagnoses; said related diagnoses, syndromes and descriptions and illustrations; said chief complaints; said differential diagnoses; said reviews of systems; said physical examinations; and said information and data on health, health-care, health-care services, organs and anatomical sites and parts of humans and physicians' practices relating to and interacting with individual specific diagnoses, chief complaints, differential diagnoses, reviews of systems, physical examinations and related information and data on diseases and disorders, health, health-care, health-care services, organs and anatomical sites and parts of humans displayed on Web pages.

6. The system of individual interactive templates according to claim 5 comprises generated, scanned, related, compiled and updated information and data on individual groups of diagnoses; said related diagnoses, syndromes and descriptions and illustrations; said chief complaints; said differential diagnoses; said reviews of systems; said physical examinations; and said information and data on health, health-care, health-care services, organs and anatomical sites and parts of humans and physicians' practices.

7. A method for associating or relating individual groups of diagnoses of diseases, disorders and illnesses affecting individual systems of organs, parts and anatomical sites or organs, parts and anatomical sites of humans and related diagnoses, syndromes, descriptions and illustrations of diseases, disorders and illnesses, chief complaints, differential diagnoses, reviews of systems, physical examinations and information and data on related health, health-care, health-care services with individual diagnoses, differential diagnoses, reviews of systems, physical examinations and information and data on health, health-care, health-care services, organs and anatomical sites and parts of humans and physicians' practices in the databases in and manage by a SQL Server wherein said associations or relations are retrieved and displayed on Web pages wherein said associations are interactive and wherein said diagnoses, chief complaints, differential diagnoses, reviews of systems, physical examinations and related information and data on diseases and disorders, health, health-care, health-care services, human organs and anatomical sites and parts and physicians' practices are interactive and expressed to, viewed by and interactive with physicians and patients using computers, portable and wireless electronic communication devices enabled by Web browsers via wireless or cable connections and the Internet and wherein said diagnoses, syndromes and descriptions of individual diseases, disorders and illnesses affecting said organs, parts and anatomical sites, chief complaints, differential diagnoses, reviews of systems, physical examinations, information and data on health, health-care, health-care services, organs and anatomical parts and sites and physicians' practices are generated, submitted, related and stored in the databases in and manage by said SQL Server and said associations and updates are submitted, related and stored in the databases in and manage by said SQL Server in a computer server or computer servers in a network or networks of computers, portable and wireless electronic communication devices and said computer server or servers to enhance or optimize the accuracy of the recording of said information and data, to assist with and/or facilitate the medical decision makings and reduce or eliminate errors in decision makings of physicians and patients, to improve and increase the efficiency of the processes of generating and recording health and health-care information and data, to expedite the process or processes of entering and recording of said information and data into said database or databases by physicians and patients and to reduce the repetitive efforts of physicians' productions of same or similar said information and data and relating errors comprises:
a process for creating a SQL database or SQL databases comprising individual diagnoses of diseases, disorders and illnesses;
a process for creating a SQL database or SQL databases comprising individual diagnoses of diseases and disorders and relating diagnoses, syndromes and descriptions and illustrations of diseases, disorders and illnesses;
a process for creating a SQL database or SQL databases comprising individual diagnoses of diseases and disorders affecting organs, parts and anatomical sites of humans;
a process for creating a SQL database or SQL databases comprising individual groups of diagnoses of diseases and disorders affecting organs, parts and anatomical sites of humans;
a process for creating a SQL database or SQL databases comprising individual groups of diagnoses of diseases and disorders affecting individual systems of organs, parts and anatomical sites of humans;
a process for creating a SQL database or SQL databases descriptions and illustrations of individual diseases, disorders and illnesses affecting organs, parts and anatomical sites of humans;
a process for creating a SQL database or SQL databases comprising descriptions and illustrations of individual diseases, disorders and illnesses affecting individual systems of organs, parts and anatomical sites of humans;
a process for creating a SQL database or SQL databases comprising signs and symptoms relating to individual diagnoses of diseases, disorders and illnesses;
a process for creating a SQL database or SQL databases comprising signs and symptoms relating to individual groups of diagnoses of diseases, disorders and illnesses affecting individual systems of organs, parts and anatomical sites of humans;
a process for creating a SQL database or SQL databases comprising signs and symptoms relating to individual groups of diagnoses of diseases, disorders and illnesses affecting organs, parts and anatomical sites of humans;
a process for creating SQL databases comprising individual diagnoses and related diagnoses, syndromes and descriptions and illustrations of individual diseases, disorders and illnesses affecting organs, parts and anatomical sites of people and related chief complaints, differential diagnoses, family histories, genetics, immunizations, laboratories, imaging, body fluid tests and tissues examinations, assessment and plan, medications, treatments, procedures, surgeries, recommendations, guidelines, referrals, follow-ups, organs and anatomical sites and parts of humans and physicians' practices;
a process for creating SQL databases comprising individual groups of diagnoses and related diagnoses, syndromes and descriptions and illustrations of individual diseases, disorders and illnesses affecting organs, parts and anatomical sites of people and related chief complaints, differential diagnoses, family histories, genetics, immunizations, laboratories, imaging, body fluid tests and tissues examinations, assessment and plan, medications, treatments, procedures, surgeries, recommendations, guidelines, referrals, follow-ups, organs and anatomical sites and parts of humans and physicians' practices;
a process for creating a SQL database or SQL databases comprising individual diagnoses of diseases, disorders and illnesses;
a process for creating a SQL database or SQL databases comprising individual groups of diagnoses of diseases, disorders and illnesses affecting individual systems of organs, parts and anatomical sites of humans;
a process for creating a SQL database or SQL databases comprising individual groups of diagnoses of diseases, disorders and illnesses affecting organs, parts and anatomical sites of humans;
a process for creating a SQL database or SQL databases comprising said individual diagnoses and signs and symptoms of chief complaints relating to said individual diagnoses;
a process for creating a SQL database or SQL databases comprising said individual groups of diagnoses and signs and symptoms of chief complaints relating to said individual groups of diagnoses;
a process for creating SQL databases comprising differential diagnoses, reviews of systems, physical examinations, information and data on health, health-care, health-care services, organs and anatomical sites and parts of humans and physicians' practices, family histories, genetics, immunizations, laboratories, imaging, body fluid tests and tissues examinations, assessment and plan, medications, treatments, procedures, surgeries, recommendations, guidelines, referrals and follow-ups relating to said diagnoses;
a process for creating interactive individual groups of diagnoses of diseases, disorders and illnesses affecting individual systems of organs, parts and anatomical sites or organs, parts and anatomical sites of humans;
a process for associating and interacting said interactive individual groups of diagnoses with individual specific diagnoses displayed on said Web pages;
a process for creating and displaying interactive individual diagnoses on said Web pages associating and interactive with individual specific diagnoses displayed on said Web pages;
a process for associating and interacting interactive individual diagnoses on said Web pages with individual specific diagnoses displayed on said Web pages;
a process for creating and displaying interactive individual diagnoses of diseases, disorders and illnesses affecting individual systems of organs, parts and anatomical sites of humans or organs, parts and anatomical sites of humans;
a process for creating and displaying interactive individual diagnoses on said Web pages associating and interactive with individual specific chief complaints displayed on said Web pages;
a process for associating and interacting interactive individual diagnoses on Web pages with individual specific chief complaints displayed on said Web pages;
a process for creating and displaying interactive individual chief complaints on Web pages associating and interactive with individual specific diagnoses displayed on said Web pages;
a process for creating and displaying interactive individual groups of diagnoses on Web pages associating and interactive with individual chief complaints displayed on said Web pages;
a process for associating and interacting interactive individual groups of diagnoses on Web pages with individual chief complaints displayed on said Web pages;
a process for creating and displaying interactive individual chief complaints on Web pages associating and interactive with individual specific groups of diagnoses displayed on said Web pages;
a process for creating and displaying interactive differential diagnoses on Web pages associating and interactive with individual specific diagnoses;
a process for associating and interacting interactive differential diagnoses on Web pages with individual specific diagnoses;
a process for associating and interacting interactive differential diagnoses on Web pages with individual groups of diagnoses;
a process for associating and interacting interactive individual groups of differential diagnoses on Web pages with chief complaints displayed on said Web pages;
a process for associating and interacting interactive chief complaints with individual differential diagnoses on Web pages displayed on said Web pages;
a process for creating and displaying interactive chief complaints on Web pages associating and interactive with individual groups of differential diagnoses displayed on said Web pages;
a process for creating and displaying interactive individual groups of differential diagnoses on Web pages associating and interactive with chief complaints displayed on said Web pages;
a process for creating and displaying interactive diagnoses, individual groups of diagnoses, reviews of systems, physical examinations, family histories, genetics, immunizations, laboratories, imaging, body fluid tests and tissues examinations, assessment and plan, medications, treatments, procedures, surgeries, recommendations, guidelines, referrals and follow-ups associating and interactive with individual specific diagnoses and signs and symptoms affecting organs, parts and anatomical sites of humans, descriptions and illustrations of individual diseases, disorders and illnesses affecting organs, parts and anatomical sites of people and chief complaints, reviews of systems, physical examinations, organs and anatomical sites and parts of humans and physicians' practices, family histories, genetics, immunizations, laboratories, imaging, body fluid tests and tissues examinations, assessment and plan, medications, treatments, procedures, surgeries, recommendations, guidelines, referrals and follow-ups displayed on said Web pages;
a process for associating and interacting interactive diagnoses, individual groups of diagnoses, reviews of systems, physical examinations, family histories, genetics, immunizations, laboratories, imaging, body fluid tests and tissues examinations, assessment and plan, medications, treatments, procedures, surgeries, recommendations, guidelines, referrals and follow-ups with individual specific diagnoses and signs and symptoms affecting organs, parts and anatomical sites of humans, descriptions and illustrations of individual diseases, disorders and illnesses affecting organs, parts and anatomical sites of people and chief complaints, reviews of systems, physical examinations, organs and anatomical sites and parts of humans and physicians' practices, family histories, genetics, immunizations, laboratories, imaging, body fluid tests and tissues examinations, assessment and plan, medications, treatments, procedures, surgeries, recommendations, guidelines, referrals and follow-ups displayed on said Web pages;
a process for operating and maintaining operating and functioning computer servers having networking capability wherein computer programs and software including Java Script, AJAX, HTML, XHTML and the unique innovative computer programs and software for effecting and enabling said processes; and
a process for using Web browsers to retrieve and display said information and data in said database or databases in said SQL Server in said computer server or servers which are viewed on Web pages appearing on viewing screens, used and expanded by physicians and patients using said computers, portable and wireless communication devices to access said computer server or servers in said network or networks via the Internet.

8. The method according to claim 7 wherein associating or relating individual groups of diagnoses of diseases, disorders and illnesses and related diagnoses, syndromes, descriptions and illustrations of diseases, disorders and illnesses, chief complaints, differential diagnoses, reviews of systems, physical examinations and information and data on related health, health-care, health-care services with specific individual diagnoses, differential diagnoses, reviews of systems, physical examinations and information and data on diseases and disorders, health, health-care, health-care services, organs and anatomical sites and parts of humans and physicians' practices and said associations and updates are submitted, related and stored in the databases in and manage by said SQL Server comprises a process for generating, displaying and using individual interactive drop-down lists comprising individual diagnoses, individual groups of diagnoses, related diagnoses, descriptions and illustrations of individual diseases, disorders and illnesses, chief complaints, reviews of systems, physical examinations, organs and anatomical sites and parts of humans, physicians' practices, family histories, genetics, immunizations, laboratories, imaging, body fluid tests and tissues examinations, assessment and plan, medications, treatments, procedures, surgeries, recommendations, guidelines, referrals and follow-ups.

9. The method according to claim 7 wherein associating or relating individual groups of diagnoses of diseases, disorders and illnesses and related diagnoses, syndromes, descriptions and illustrations of diseases, disorders and illnesses, chief complaints, differential diagnoses, reviews of systems, physical examinations and information and data on related health, health-care, health-care services with specific individual diagnoses, differential diagnoses, reviews of systems, physical examinations and information and data on diseases and disorders, health, health-care, health-care services, organs and anatomical sites and parts of humans and physicians' practices and said associations and updates are submitted, related and stored in the databases in and manage by said SQL Server comprises a process for generating, displaying and using individual interactive templates comprising individual diagnoses, individual groups of diagnoses, related diagnoses, descriptions and illustrations of individual diseases, disorders and illnesses, chief complaints, reviews of systems, physical examinations, organs and anatomical sites and parts of humans, physicians' practices, family histories, genetics, immunizations, laboratories, imaging, body fluid tests and tissues examinations, assessment and plan, medications, treatments, procedures, surgeries, recommendations, guidelines, referrals and follow-ups.

10. The method according to claim 7 wherein associating or relating individual groups of diagnoses of diseases, disorders and illnesses and related diagnoses, syndromes, descriptions and illustrations of diseases, disorders and illnesses, chief complaints, differential diagnoses, reviews of systems, physical examinations and information and data on related health, health-care, health-care services with specific individual diagnoses, differential diagnoses, reviews of systems, physical examinations and information and data on diseases and disorders, health, health-care, health-care services, organs and anatomical sites and parts of humans and physicians' practices and said associations and updates are submitted, related and stored in the databases in and manage by said SQL Server comprises a process for generating, displaying and using individual interactive panels comprising individual diagnoses, individual groups of diagnoses, related diagnoses, descriptions and illustrations of individual diseases, disorders and illnesses, chief complaints, reviews of systems, physical examinations, organs and anatomical sites and parts of humans, physicians' practices, family histories, genetics, immunizations, laboratories, imaging, body fluid tests and tissues examinations, assessment and plan, medications, treatments, procedures, surgeries, recommendations, guidelines, referrals and follow-ups.

11. The method according to claim 7 wherein said process for associating and interacting said interactive individual groups of diagnoses with individual specific diagnoses displayed on said Web pages comprises a process for generating, displaying and using individual interactive drop-down lists comprising diagnoses.

12. The method according to claim 7 wherein said process for associating and interacting said interactive individual groups of diagnoses with individual specific diagnoses displayed on said Web pages comprises a process for generating, displaying and using individual interactive drop-down lists comprising individual groups of diagnoses.

13. The method according to claim 7 wherein said process for associating and interacting said interactive individual groups of diagnoses with individual specific diagnoses displayed on said Web pages comprises a process for generating, displaying and using individual interactive templates comprising diagnoses.

14. The method according to claim 7 wherein said process for associating and interacting said interactive individual groups of diagnoses with individual specific diagnoses displayed on said Web pages comprises a process for generating, displaying and using individual interactive templates comprising individual groups of diagnoses.

15. The method according to claim 7 wherein said wherein said process for creating and displaying interactive chief complaints on Web pages associating and interactive with individual specific diagnoses displayed on said Web pages comprises a process for generating, displaying and using interactive templates comprising chief complaints comprising signs and symptoms and related palliative and provocative items, quality, regions, severity and temporal factor.

16. The method according to claim 7 wherein said wherein said process for creating and displaying interactive chief complaints on Web pages associating and interactive with individual specific diagnoses displayed on said Web pages comprises a process for generating, displaying and using interactive drop-down lists comprising chief complaints comprising signs and symptoms and related palliative and provocative items, quality, regions, severity and temporal factor.

17. The method according to claim 7 wherein said process for creating and displaying interactive individual chief complaints on Web pages associating and interactive with individual specific diagnoses displayed on said Web pages comprises a process for generating, displaying and using interactive panels comprising chief complaints comprising signs and symptoms and related palliative and provocative items, quality, regions, severity and temporal factors.

18. The method according to claim 7 wherein said process for associating and interacting interactive diagnoses, individual groups of diagnoses, reviews of systems, physical examinations, family histories, genetics, immunizations, laboratories, imaging, body fluid tests and tissues examinations, assessment and plan, medications, treatments, procedures, surgeries, recommendations, guidelines, referrals and follow-ups with individual specific diagnoses and signs and symptoms affecting organs, parts and anatomical sites of humans, descriptions and illustrations of individual diseases, disorders and illnesses, chief complaints, reviews of systems, physical examinations, organs and anatomical sites and parts of humans and physicians' practices, family histories, genetics, immunizations, laboratories, imaging, body fluid tests and tissues examinations, assessment and plan, medications, treatments, procedures, surgeries, recommendations, guidelines, referrals and follow-ups displayed on said Web pages comprises a process for using interactive templates.

19. A method for expressing the associations of and interacting individual groups of diagnoses and individual groups of signs and symptoms of diseases, disorders and illnesses affecting individual systems of organs, parts and anatomical sites or organs, parts and anatomical sites of humans and related diagnoses, syndromes, descriptions and illustrations of diseases, disorders and illnesses, chief complaints, differential diagnoses, reviews of systems, physical examinations and information and data on related health, health-care, health-care services, organs and anatomical sites and parts of humans with diagnoses, chief complaints, differential diagnoses, reviews of systems, physical examinations and information and data on health, health-care, health-care services, and organs, anatomical sites and parts, representations and illustrations of humans and physicians' practices by using interactive templates, drop-down lists and panels on Web pages on the viewing screens of computers, portable and wireless electronic communication devices enabled by Web browsers wherein said diagnoses, chief complaints, differential diagnoses, reviews of systems, physical examinations and related information and data on diseases and disorders, health, health-care, health-care services, human organs and anatomical sites and parts are interactive and are expressed to, viewed by and interactive with physicians and patients using computers, portable and wireless electronic communication devices via wireless or cable connections and the Internet and wherein said diagnoses, syndromes and descriptions of individual diseases, disorders and illnesses, chief complaints, differential diagnoses, reviews of systems, physical examinations, information and data on health, health-care, health-care services, physicians' practices, organs, parts and anatomical sites, representations and illustrations are created, submitted, scanned, related and stored in the databases in and manage by a SQL Server wherein said associations and updates of said associations are submitted, scanned, related and stored in the databases in and manage by said SQL Server in a computer server or computer servers in a network or networks of said computers, portable and wireless electronic communication devices and said computer servers operating common computer programs and software and the unique innovative computer programs and software for effecting and enabling said processes to enhance or optimize the accuracy of the recording of said information and data, to assist with and/or facilitate the medical decision makings and reduce or eliminate errors in decision makings of physicians and patients, to improve and increase the efficiency of the processes of generating and recording health and health-care information and data, to expedite the process or processes of entering and recording of said information and data into said database or databases by physicians and patients and to reduce the repetitive efforts of physicians' productions of same or similar said information and data and relating errors comprises:
a process for expressing individual groups of diagnoses of diseases, disorders and illnesses affecting individual systems of organs, parts and anatomical sites or organs, parts and anatomical sites of humans;
a process for expressing said individual groups of diagnoses and related diagnoses, syndromes, descriptions and illustrations of diseases, disorders and illnesses, chief complaints, differential diagnoses, reviews of systems, physical examinations and information and data on related health, health-care, health-care services, organs and anatomical sites and parts of humans;
a process for associating said individual groups of diagnoses of diseases, disorders and illnesses and related diagnoses, syndromes, descriptions and illustrations of diseases, disorders and illnesses, chief complaints, differential diagnoses, reviews of systems, physical examinations and information and data on related health, health-care, health-care services, organs and anatomical sites and parts of humans with specific individual diagnoses, chief complaints, differential diagnoses, reviews of systems, physical examinations and information and data on diseases and disorders, health, health-care, health-care services, and organs, anatomical sites and parts and representations or illustrations of humans on Web pages;
a process for expressing said individual groups of diagnoses by physicians or patients expressing individual diagnoses of said individual groups of diagnoses;
a process for expressing said individual groups of diagnoses of diseases, disorders and illnesses by physicians or patients expressing an alphabetical or alphanumerical component of individual diagnoses of said individual groups of diagnoses;
a process for expressing said individual groups of diagnoses of diseases, disorders and illnesses by physicians or patients expressing signs and symptoms relating to said individual groups of diagnoses;
a process for expressing signs and symptoms relating to said individual groups of diagnoses by physicians or patients expressing individual component diagnoses of said individual groups of diagnoses;
a process for expressing specific said individual diagnoses by physicians or patients expressing related signs and symptoms of individual diseases, disorders and illnesses;
a process for expressing specific signs and symptoms relating to said individual diagnoses by physicians or patients expressing individual component diagnoses of said individual groups of diagnoses;
a process for using at least one alphabet of a word component and a space component of a diagnosis to express said individual groups of diagnoses;
a process for using a plurality of alphabets of a diagnosis to express said individual groups of diagnoses;
a process for using a plurality of alphanumerics of a diagnosis to express said individual groups of diagnoses;
a process for using a plurality of alphabets and at least a space between alphabetical components of a diagnosis to express said individual groups of diagnoses;
a process for using at least one alphabet and at least one numerics and a space component of a diagnosis to express said individual groups of diagnoses;
a process for using a word component and a space component of a diagnosis to express said individual groups of diagnoses;
a process for using a plurality of word components and a plurality of space components of a diagnosis to express said individual groups of diagnoses;
a process for using a word component, a space component, at least one alphabet and/or at least one numerics of a diagnosis to express said individual groups of diagnoses;
a process for using a word component and a space component of signs and symptoms relating to individual diagnoses to express said individual groups of diagnoses;
a process for using a word component and a space component of signs and symptoms relating to individual diagnoses to express said individual groups of diagnoses and relating signs and symptoms;
a process for using a word component and a space component of signs and symptoms relating to individual diagnoses to express said individual groups of diagnoses associating with individual diagnoses on Web pages;
a process for using a word component and a space component of signs and symptoms relating to individual diagnoses to express said individual groups of diagnoses and relating signs and symptoms associating with individual diagnoses on Web pages;
a process for using a plurality of word components and a plurality of space components of signs and symptoms relating to individual diagnoses to express said individual groups of diagnoses;
a process for using a plurality of word components and a plurality of space components of signs and symptoms relating to individual diagnoses to express said individual groups of diagnoses and relating signs and symptoms;
a process for using a plurality of word components and a plurality of space components of signs and symptoms relating to individual diagnoses to express said individual groups of diagnoses associating with individual diagnoses on Web pages;
a process for using a word component and a space component of signs and symptoms relating to individual diagnoses to express said individual groups of diagnoses associating with chief complaints, differential diagnoses, reviews of systems, physical examinations and information and data on diseases and disorders, health, health-care, health-care services, and organs, anatomical sites and parts, representations and illustrations of humans and physicians' practices on Web pages;
a process for using a word component and a space component of signs and symptoms relating to individual diagnoses to express said individual groups of diagnoses and relating signs and symptoms on Web pages;
a process for using a plurality of word components and a plurality of space components of signs and symptoms relating to individual diagnoses to express said individual groups of diagnoses on Web pages;
a process for using a plurality of word components and a plurality of space components of signs and symptoms relating to individual diagnoses to express said individual groups of diagnoses and relating signs and symptoms on Web pages;
a process for using a word component and a space component of signs and symptoms relating to individual diagnoses to express individual diagnoses on Web pages;
a process for using a plurality of word components and a plurality of space components of signs and symptoms relating to individual diagnoses to express said individual diagnoses on Web pages;
a process for creating and managing said databases by using the stored procedures of said SQL Server in said computer server or servers;
a process for using Java Script, AJAX, PHP, HTML, XHTML in said computer server or servers;
a process for using innovative computer programs and software with Java Script, AJAX, PHP, HTML and XHTML in said computer server or servers;
a process for using said computer programs and software for effecting said processes in said computer server or servers;
a process for operating a network or networks of said computers, portable and wireless electronic communication devices, said operating and functioning computer servers comprising a plurality of processors, memories, server operating system, said SQL Server, Web server, computer scripting language programs and said computer programs and software communicating with and commanding said SQL Server and a networking capability and Web browsers;
a process for using said computer scripting languages and innovative computer programs and software to communicate with and command said SQL Server;
a process for using said computer scripting languages and innovative computer programs and software to generate, expand and manage information and data in the database or databases in and manage by said SQL Server;
a process for using computer scripting language programs and innovative computer programs and software to communicate with and command SQL Server and database or databases and Web browser;
a process for using said computer scripting languages and innovative computer programs and software for retrieving and displaying on Web pages said information and data in said databases in and manage by said SQL Server;
a process for using said computer scripting language and innovative computer programs for generating, storing, relating and managing said information and data in said database or databases in and manage by said SQL Server;
a process for using said computer scripting languages and innovative computer programs and software to generate, relate and manage health, health-care and health-care-service information and data and the health, health-care and health-care-services information and data products and outcomes of the generations, relations, managements and uses of said information and data in the database or databases which are submitted, stored, related, compiled or pooled in said databases in and manage by said SQL Server;
a process for coupling a Web browser to said innovative computer programs and software;
a process for coupling said innovative computer programs and software and said SQL Server and SQL databases in said computer server or servers;
a process for generating, relating and managing health, health-care and health-care-service information and data and the health, health-care and health-care-service information and data products and outcomes of the generations, relations, managements and uses of said information and data in the database or databases which are submitted, stored, related, compiled or pooled in said database or databases in and manage by said SQL Server;
a process for using said computer scripting languages and innovative computer programs and software to generate, relate and manage said information and data and said products and outcomes and to retrieve, display on Web pages, and to effect the views and uses of said information and data and products and outcomes by patients and physicians; and
a process for using a Web browser to retrieve and display said information and data in said database or databases in said SQL Server in said computer server or servers which are viewed on said Web pages on the viewing screens and used and expanded by physicians and patients using said computers, portable and wireless communication devices to access said computer server or servers in said network or networks via the Internet.
